(19) United States
(12) Patent Application Publication
(10) Pub. No.: US 2015/0160088 A1
(43) Pub. Date: Jun. 11, 2015

(54) EYE PRESSURE INDICATOR DEVICE

(71) Applicants: Gloria Wu, Saratoga, CA (US); Agastya Gupta, Saratoga, CA (US)

(72) Inventors: Gloria Wu, Saratoga, CA (US); Agastya Gupta, Saratoga, CA (US)

(21) Appl. No.: 14/563,412

(22) Filed: Dec. 8, 2014

Related U.S. Application Data
(60) Provisional application No. 61/913,241, filed on Dec. 6, 2013.

(51) Int. Cl. G01L 19/00; G01L 7/00

(52) U.S. Cl. CPC G01L 19/00; G01L 7/00

(57) ABSTRACT

A diagnostic kit for testing eye pressure of a human eye is provided. The kit comprises at least one pressure indicator device calibrated to indicate the pressure of the human eye; and instructions on how to use the at least one pressure indicator device

This application claims the benefit of priority to U.S. 61/913,241 entitled “GLAUCOMA TEST BALL” filed on 6 Dec. 2013, which application is hereby incorporated herein by reference.

### FIELD

Embodiments of the invention relate to diagnostic devices

### BACKGROUND

Glaucoma is a leading cause of blindness in the United States and affects approximately 6 million Americans. The disease involves a painless progressive loss of vision.

Glaucoma may be detected by an eye care practitioner through measurement of the intraocular pressure of the eye using a tonometer. However, many people simply do not avail themselves of such measurements. Thus, many people have glaucoma and do not know this until it is too late to prevent a significant loss of vision associated with the condition

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

According to a first aspect of the invention, there is provided a diagnostic kit for testing eye pressure of a human eye, comprising: at least one pressure indicator device calibrated to indicate the pressure of the human eye; and instructions on how to use the at least one pressure indicator device.

Other aspects of the invention will be apparent from the detailed description that follows.

### BRIEF DESCRIPTION OF THE DRAWINGS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

The present invention, in accordance with one or more various embodiments, is described in detail with reference to the following figures. The drawings are provided for purposes of illustration only and merely depict exemplary embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 shows pressure indicator device in accordance with one embodiment of the invention.

FIG. 2 shows pressure indicator device in accordance with another embodiment of the invention.

FIG. 3 shows a diagnostic kit in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a pressure indicator device that may be used for testing the eye pressure of a human eye. In one embodiment, the pressure indicator device may comprise a three dimensional body calibrated to indicate the pressure of a human eye, as will be explained

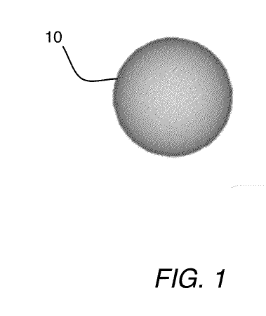

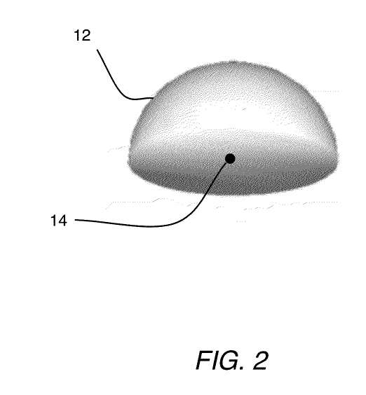

Referring to FIG. 1, reference numeral 10 generally indicates a pressure indicator device in the form of a ball, in accordance with one embodiment. In another embodiment, the pressure indicator device may comprise a hemispherical or dome-shaped body 12, as is shown in FIG. 2 of the drawings.

The pressure indicator devices 10 and 12 may be formed from a solid elastically deformable material such as rubber. In some embodiments, the devices 10 and 12 may be filled with a fluid, preferably a sterile fluid, e.g. saline solution. For example, the device 12 includes an injection port (one-way valve) 14 to allow the fluid to be introduced into the device 12.

The pressure indicator devices 10 and 12 may be calibrated to simulate a desired eye pressure. For example, a normal eye pressure for an adult is considered to be 20 mm Hg. Thus, in one embodiment, the devices 10 and 12 are calibrated to a pressure of 20 mm Hg.

For measurement of eye pressure, a user is instructed to touch his/her eyelid to gauge the pressure of his/her eyeball and then to touch the ball 10 or 12 in order to assess whether the pressure of the eye ball feels the same.

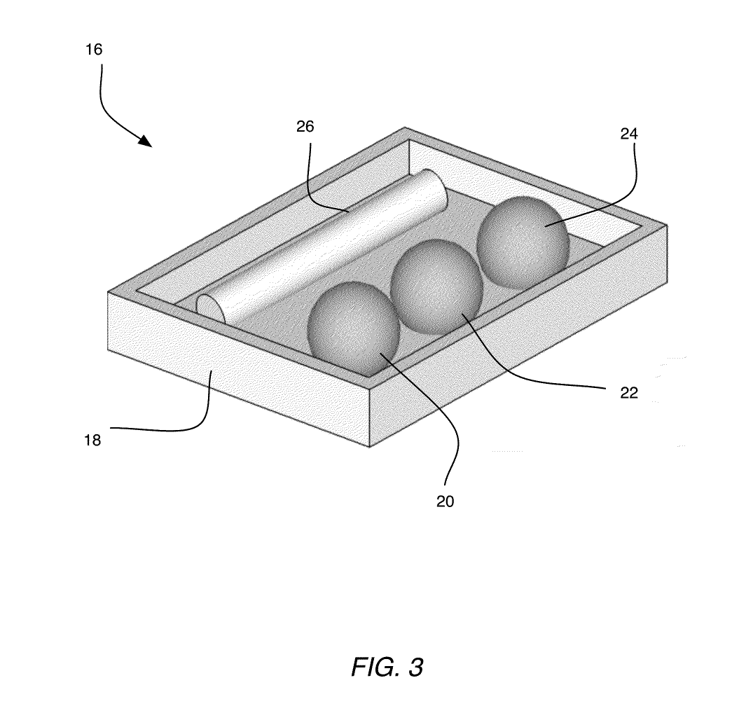

The pressure indicator devices of the present invention may be supplied in kit form. For example, FIG. 3 shows a kit 16 in accordance with one embodiment. The kit 16 includes a container 18 and a plurality of balls 20-24. The balls 20-24 are similar to the ball 10 described above. Each of the balls 20-24 is calibrated to a difference pressure. For example, the ball 20 may be calibrated to a pressure of 10 mm Hg, the ball 22 to a pressure of 20 mm Hg, and the ball 24 to a pressure of 30 mm Hg. The kit 16 also includes instructions on how to use the ball 20-24 to determine eye pressure. The instructions are written on scrolled paper 26 in the example shown. However, it is to be understood that the instructions may be provided in electronic for, such as in the form of an electronic document on a Universal Serial Bus (USB) drive. The instructions will direct a user on how to use the balls of the kit.

The ball 20 which is calibrated to a pressure of 10 mm Hg simulates “low normal” pressure. This is the eye pressure that eye surgeons would want their patients to have post operatively after certain glaucoma or other eye procedures.

The ball 22 which is calibrated to a pressure of 20 mm Hg simulates “normal” pressure.

The ball 24 which is calibrated to a pressure of 30 mm Hg simulates “urgent pressure” This pressure is considered to be abnormally high for any patient after any form of eye surgery. Patients with this eye pressure are required to seek treatment by an eye care practitioner.

Although not shown in the kit 16, a fourth ball calibrated to a pressure of 40 mm Hg may also be provided. This ball is used to test for eye pressures considered to be “emergency pressures” and patients exhibiting this pressure are required to seek treatment by an eye care practitioner immediately.

The pressure of the balls in the kit 16 are suitable for measuring pressures of an adult eye. The pressures associated with the eyes of children are different from those of an adult. Thus, a kit such as the kit 16 may be manufactured/assembled with a ball calibrated to a child's eye pressure standard of 8 mm Hg.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples.

1. A diagnostic kit for testing eye pressure of a human eye, comprising:
at least one pressure indicator device calibrated to indicate the pressure of the human eye; and
instructions on how to use the at least one pressure indicator device.

2. The kit of claim 1, wherein the pressure indicator device comprise a three dimensional body.

3. The kit of claim 2, wherein the pressure indicator device is responsive to human touch to simulate an intraocular pressure measurement considered to be normal eye pressure for an adult's eye.

4. The kit of claim 3, wherein the intraocular pressure measurement is 20 mm Hg.

5. The kit of claim 2, wherein the pressure indicator device is responsive to human touch to simulate an intraocular pressure measurement considered to be normal eye pressure for a child's eye.

6. The kit of claim 5, wherein the intraocular pressure measurement is 8 mm Hg.

7. The kit of claim 1, comprising a plurality of pressure indicator devices.

8. The kit of claim 7, wherein each of the pressure indicator devices simulates an intraocular pressure measurement selected from the group consisting of 10 mm Hg, 20 mm Hg, 30 mm Hg, and 40 mm Hg.

9. The kit of claim 2, wherein the three dimensional body comprises a ball.

10. The kit of claim 2, wherein the three dimensional body comprises a dome-shaped body.

11. The kit of claim 2, wherein the three dimensional body comprises a solid body and is elastically deformable.

12. The kit of claim 1, wherein said body is of rubber.

13. The kit of claim 2, wherein the three dimensional body is fluid filled.

14. The kit of claim 13, wherein the fluid comprise a sterile liquid.
